(19) United States
(12) Patent Application Publication
(10) Pub. No.: US 2014/0016338 A1
(43) Pub. Date: Jan. 16, 2014

(54) LIGHT GUIDING LIGHT STRIP STRUCTURE FOR CARS AND CAR LIGHT STRUCTURE

(71) Applicant: SONAR AUTO PARTS CO., LTD., New Taipei City (TW)

(72) Inventor: HSIU-PEN YANG, NEW TAIPEI CITY (TW)

(73) Assignee: SONAR AUTO PARTS CO., LTD., NEW TAIPEI CITY (TW)

(21) Appl. No.: 13/728,425

(22) Filed: Dec. 27, 2012

(30) Foreign Application Priority Data
Jul. 11, 2012 (TW) 101213400

(51) Int. Cl. B60Q 1/26

(52) U.S. Cl. CPC B60Q 1/26
USPC 362/487

(57) ABSTRACT

A light guiding light strip structure for cars includes: at least one strip shaped light guiding element and at least one light emitting element. The at least one strip shaped light guiding element extends along a defined path, wherein each light guiding element has an outer surface, a concave groove formed along the defined path and concaving from the outer surface, and a reflective layer disposed on the concave groove. At least one light emitting element is proximal to an end of at least one of the light guiding element. A car light structure includes at least one light body, wherein the at least one strip shaped light guiding element is disposed within the at least one light body.

### BACKGROUND OF THE INVENTION

1. Field of the Invention

The present invention relates to a light guiding light strip structure and a car light structure; in particular, to a light guiding light strip structure for cars and a car light structure which are able to produce a light strip.

2. Description of Related Art

A typical early car or scooter light generally is a light bulb with a shade. The light bulb emits light which shines through the shade, thereby achieving a lighting or signaling effect.

Later, a strip shaped car light is developed which arranges multiple light bulbs (or light-emitting diodes) in a strip, and then covers the multiple light bulbs with a shade. When the multiple light bulbs produce light which shines through the shade, people can observe a “light strip.” Due to the special visual effect of a light strip, it more easily catches people's attention. Therefore strip shaped car lights are better at providing signaling effects.

However, the “light strip” displayed by the above arrangement of light bulbs is still not ideal. People can tell that the parts closer to the light bulbs are brighter than the parts further away are. In other words, the brightness of the light strip is uneven, rendering the entire light strip with a choppy quality.

Hence, the present inventor believes the above mentioned disadvantages can be overcome, and through devoted research combined with application of theory, finally proposes the present invention which has a reasonable design and effectively improves upon the above mentioned disadvantages.

### SUMMARY OF THE INVENTION

The object of the present invention is to provide a light guiding light strip structure for cars and a car light structure, which can produce a light strip with uniform brightness to enhance the signaling effect.

One embodiment of the present disclosure provides a light guiding light strip structure, which includes at least one strip shaped light guiding element and at least one light emitting element. The at least one strip shaped light guiding element extends along a defined path, wherein each strip shaped light guiding element has an outer surface, a concave groove formed along the defined path and concaving from the outer surface, and a reflective layer disposed on the concave groove. At least one light emitting element is proximal to an end of at least one of the strip shaped light guiding element.

Another embodiment of the present disclosure provides a light guiding light strip structure, which includes at least one strip shaped light guiding element and at least one light emitting element. The at least one strip shaped light guiding element extends along a defined path, wherein each strip shaped light guiding element has an outer surface, and a reflective layer partially disposed on the concave groove. At least one light emitting element is proximal to an end of at least one of the strip shaped light guiding element.

Yet another embodiment of the present disclosure provides a light guiding light strip structure, which includes at least one strip shaped light guiding element and at least one light emitting element. A cross sectional area of the light guiding element along the direction of the two ends of the light guiding element is smaller the closer it is to the middle and larger the closer it is to one of the two ends. Each light guiding element has an outer surface and a reflective layer partially disposed on the outer surface. At least one light emitting element is proximal to an end of at least one of the light guiding element.

Another embodiment of the present disclosure provides a car light structure, which includes a light body, wherein the at least one strip shaped light guiding structure is disposed inside the light body.

In summary of the above, the embodiments of the present disclosure provides a light guiding light strip structure and a car light structure, which utilizes the design of “strip shaped light guiding element,” “light emitting element” and “light body” to produce a light strip with more uniform brightness, enhancing the signaling effect.

In order to further the understanding regarding the present invention, the following embodiments are provided along with illustrations to facilitate the disclosure of the present invention.

### BRIEF DESCRIPTION OF THE DRAWINGS

FIG. 1A shows a perspective schematic diagram of a light guiding light strip structure for cars of a first embodiment of the present disclosure;

FIG. 1B shows a front view schematic diagram of a strip shaped light guiding element of a light guiding light strip structure for cars of a first embodiment of the present disclosure;

FIG. 1C shows a cross sectional schematic diagram of a strip shaped light guiding element of a light guiding light strip structure for cars of a first embodiment of the present disclosure;

FIG. 2A shows a perspective schematic diagram of a light guiding light strip structure for cars of a second embodiment of the present disclosure;

FIG. 2B shows a front view schematic diagram of a strip shaped light guiding element of a light guiding light strip structure for cars of a second embodiment of the present disclosure;

FIG. 3A shows a perspective schematic diagram of a light guiding light strip structure for cars of a second embodiment of the present disclosure;

FIG. 3B shows a front view schematic diagram of a strip shaped light guiding element of a light guiding light strip structure for cars of a second embodiment of the present disclosure;

FIG. 4A shows a perspective schematic diagram of a light guiding light strip structure for cars of a third embodiment of the present disclosure;

FIG. 4B shows a front view schematic diagram of a strip shaped light guiding element of a light guiding light strip structure for cars of a third embodiment of the present disclosure; and

FIG. 5 shows a perspective schematic diagram of a car light structure of a fourth embodiment of the present disclosure.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

### First Embodiment

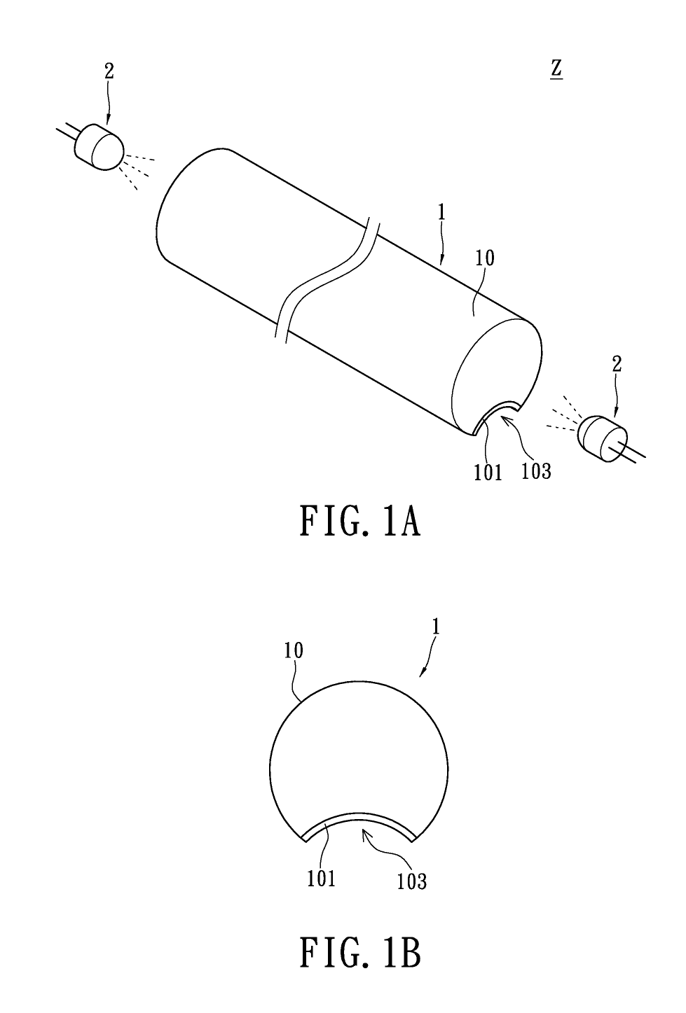

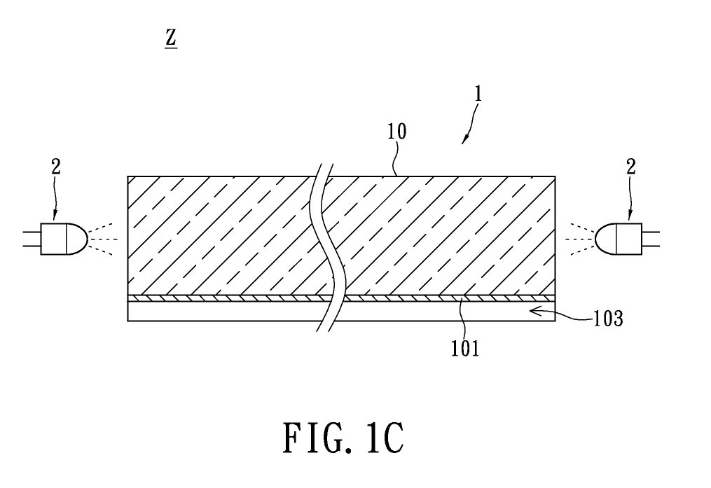

Referring to FIG. 1A to FIG. 1C, the first embodiment of the present disclosure provides a light guiding light strip structure Z for cars, which includes at least one strip shaped light guiding unit 1 and at least one light emitting unit 2. The light emitting unit 2 can be a light-emitting diode, light bulb, or other light emitting objects the type of which is not limited by the present disclosure.

As shown in FIG. 1A, the at least one strip shaped light guiding element 1 extends along a defined path. In other words, the shape of the strip shaped light guiding element 1 can be adjusted according to demand. For example, the strip shaped light guiding element 1 can extend along a straight line, curved path, and other such path in which the two ends do not connect. Additionally, each of the strip shaped light guiding element 1 has an outer surface 10, a concave groove 103 formed along the defined path and concaving from the outer surface 10, and a reflective layer 101 disposed on the concave groove 103. The shape of the concave groove 103 is roughly a semicircle. The reflective layer 101 can be produced by for example coextrusion and made of material such as titanium dioxide.

The at least one light emitting unit 2 is proximal to one end of at least one of the strip shaped light guiding element 1. As shown in FIG. 1C, the two light emitting elements 2 are respectively disposed proximally to the two ends of the strip shaped light guiding element 1. More specifically, the light produced by the light emitting element 2 is projected onto the end of the strip shaped light guiding element 1, then reaches the reflective layer 101 of the strip shaped light guiding element 1, then immediately travels in the strip shaped light guiding element 1 by methods of diffraction and scattering and not refraction, and then transmit out of the strip shaped light guiding element 1. By this configuration, the light guiding light strip structure for cars of the present disclosure can produce light strips of more uniform brightness, enhancing the signaling effect.

### Second Embodiment

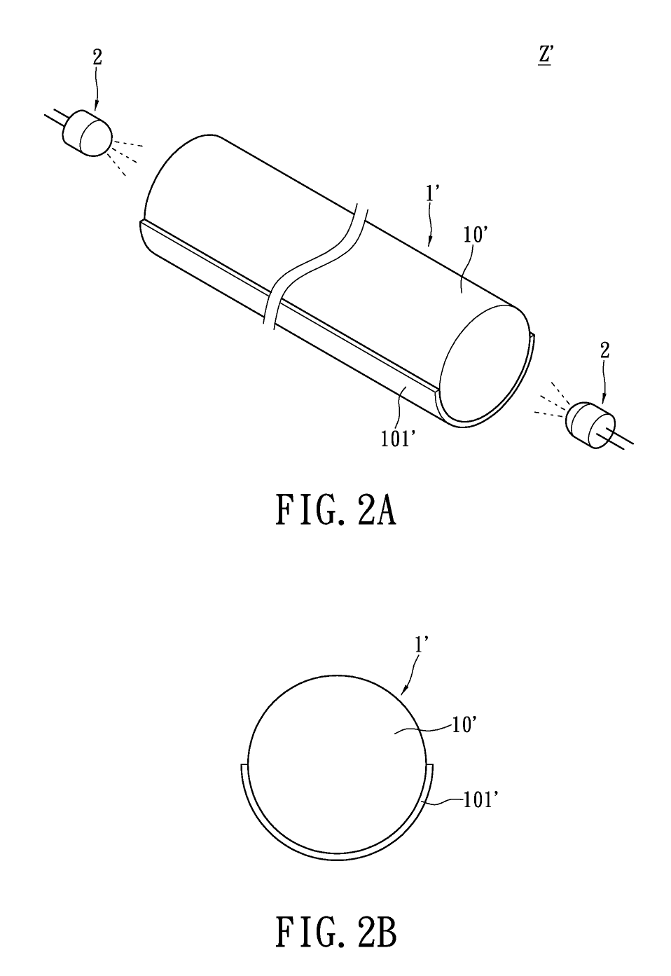

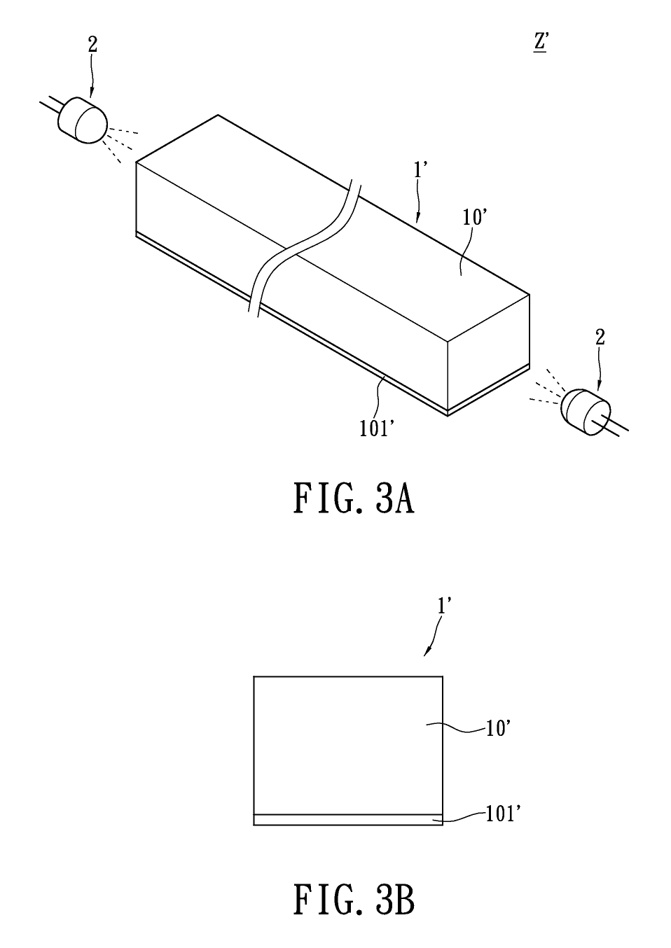

Please refer to FIG. 1A, FIG. 2A, and FIG. 3A. Comparing the three figures shows that the difference between the first and second embodiments of the present disclosure lies in: a light guiding light strip structure Z′ of the second embodiment includes at least one strip shaped light guiding element 1′ and at least one light emitting element 2.

The at least one strip shaped light guiding element 1′ extends along a defined path, wherein each strip shaped light guiding element 1′ has an outer surface 10′ and a reflective layer 101′ partially disposed on the outer surface 10′. The at least one light emitting element 2 is proximal to one end of at least one of the strip shaped light guiding element 1′. In other words, the strip shaped light guiding element 1′ of the light guiding light strip structure Z′ for cars of the second embodiment of the present disclosure has a shape of a circle, trapezoid, or other geometrical shapes.

### Third Embodiment

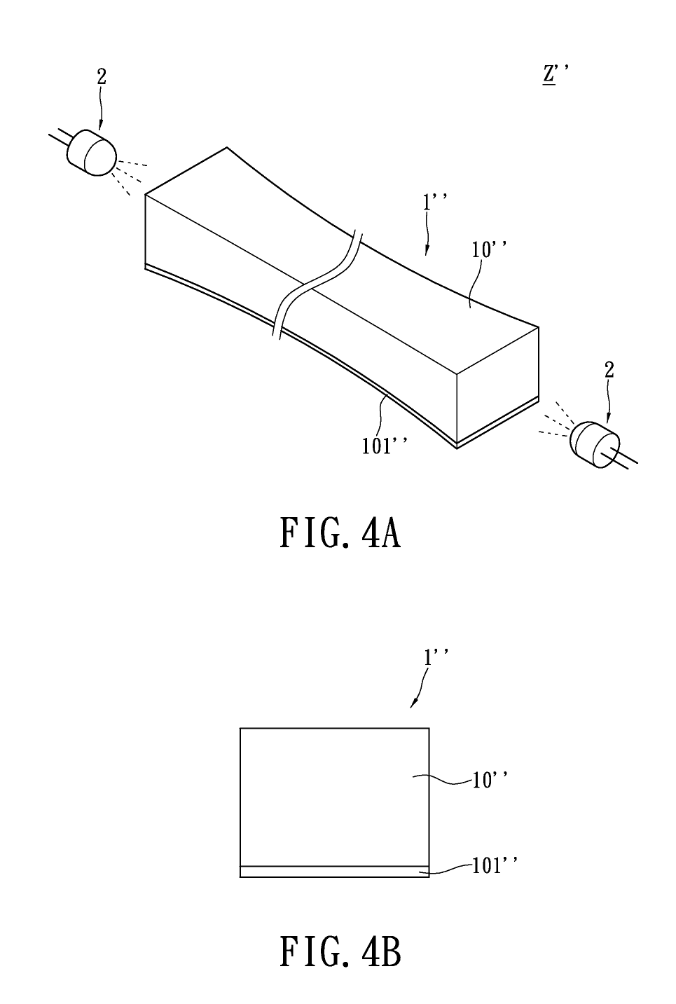

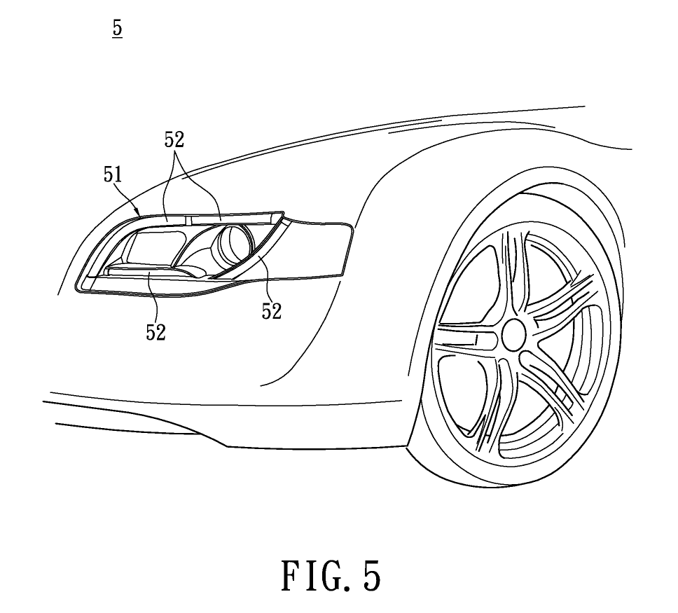

Please refer to FIG. 1A and 4A. Comparing the two figures shows that the difference between the third and the first embodiments of the present disclosure lies in: a light guiding light strip structure Z″ for cars of the third embodiment includes at least one strip shaped light guiding element 1″ and at least one light emitting element 2.

A cross sectional area of the light guiding element 1″ along the direction of the two ends of the light guiding element 1″ is smaller the closer it is to the middle and larger the closer it is to one of the two ends. Each strip shaped light guiding element 1″ has an outer surface 10″ and a reflective layer 101″ partially disposed on the outer surface 10″. At least one light emitting element 2 is proximal to an end of at least one of the strip shaped light guiding element 1″. In other words, the strip shaped light guiding element 1″ of the light guiding light strip structure Z″ of the third embodiment of the present disclosure has a gradually shrinking shape. However the present disclosure is not limited to this configuration, and can have for example a gradually enlarging, or a gradually shrinking and gradually enlarging shape.

### Fourth Embodiment

Referring to FIG. 5, the fourth embodiment of the present disclosure provides a car light structure 5 which includes at least one light body 51, wherein at least one strip shaped light guiding element 52 is disposed in the at least one light body 51. For example, the car light structure 5 can be installed in a car illumination assembly. The strip shaped light guiding element 52 can be fixed within the light body 51 by engagement, locking, or adhesives. It must be noted that the strip shaped light guiding element 52 can be a strip shaped light guiding element of the above embodiments with or without possible modifications. With this configuration, the car light structure of the present disclosure produces a light strip with more uniform brightness, enhancing the signaling effect.

### Potential Advantages of the Embodiments

In summary of the above, the embodiments of the present disclosure provide a light guiding light strip structure and a car light structure, which utilizes the design of “strip shaped light guiding element,” “light emitting element” and “light body” to produce a light strip with more uniform brightness, enhancing the signaling effect.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A light guiding light strip structure for cars, comprising:
at least one strip shaped light guiding element; and
at least one light emitting element arranged proximally to an end of at least one of the strip shaped light guiding element.

2. The light guiding light strip structure for cars according to claim 1, wherein the at least one strip shaped light guiding element extends along a predetermined path, and each strip shaped light guiding element has an outer surface, a concave groove formed along the predetermined path and concavely into the outer surface, and a reflective layer disposed on the concave groove.

3. The light guiding light strip structure for cars according to claim 1, wherein the at least one strip shaped light guiding element extends along a predetermined path, and each strip shaped light guiding element has an outer surface, and a reflective layer partially disposed on the outer surface.

4. The light guiding light strip structure for cars according to claim 1, wherein a cross sectional area of the strip shaped light guiding element along the direction of two ends of the light guiding element is smaller the closer the cross sectional area is to the middle and larger the closer the cross sectional area is to one of the two ends, and each strip shaped light guiding element has an outer surface and a reflective layer partially disposed on the outer surface.

5. A car light structure, comprising:
at least one light body;
at least one strip shaped light guiding element, disposed in the at least one light body; and
at least one light emitting element arranged proximally to an end of at least one of the strip shaped light guiding element.

6. The car light structure according to claim 5, wherein the at least one strip shaped light guiding element extends along a predetermined path, and each strip shaped light guiding element has an outer surface, a concave groove formed along the predetermined path and concavely into the outer surface, and a reflective layer disposed on the concave groove.

7. The car light structure according to claim 5, wherein the at least one strip shaped light guiding element extends along a predetermined path, and each strip shaped light guiding element has an outer surface, and a reflective layer partially disposed on the outer surface.

8. The car light structure according to claim 5, wherein a cross sectional area of the strip shaped light guiding element along the direction of two ends of the light guiding element is smaller the closer the cross sectional area is to the middle and larger the closer the cross sectional area is to one of the two ends, and each strip shaped light guiding element has an outer surface and a reflective layer partially disposed on the outer surface.
